(19) United States
(12) Patent Application Publication
(10) Pub. No.: US 2010/0019500 A1
(43) Pub. Date: Jan. 28, 2010

(54) Wind power twin generator include multiple system

(76) Inventors: Chang Z. Kim, Bloomington, CA (US); Young H. Kim, Bloomington, CA (US); Grant S. Kim, Bloomington, CA (US)

Correspondence Address: CHANG Z. KIM, 562 SOUTH ASHFORD AVE., BLOOMINGTON, CA, 92316, US

(21) Appl. No.: 12/220,774

(22) Filed: Jul. 28, 2008

(51) Int. Cl. F03D 9/00; F03D 3/02; F03D 3/04

(52) U.S. Cl. 290/55

(57) ABSTRACT

The ability of wind power twin generator include multiple system to produce more electricity in less space by using wind power smaller size twin generator that can be added as many as to meet specific needs. The fan of wind power twin generator works either wind direction from right side or left side by using wind divider. Wind power is maximized by full face of fan area.

### REFERENCES CITED

U.S. Patent Documents

| | | |
|---|---|---|
| 108593 | October 1870 | Heyworth et al. |
| 665891 | January 1901 | Fetty |
| 683935 | October 1901 | Hensel |
| 752764 | February 1904 | Dunne |
| 2224851 | December 1940 | Lea |
| 3897170 | July 1975 | Darvishian |
| 3930750 | January 1976 | Schultz |
| 4037989 | July 1977 | Huther |
| 4236504 | December 1980 | Cornelison, Jr. |
| 4321005 | March 1982 | Black |
| 4382190 | May 1983 | Jacobson |
| 4382191 | May 1983 | Potter |
| 4406584 | September 1983 | Stepp |
| 4419587 | December 1983 | Benton |
| 4508972 | April 1985 | Willmouth |
| 5299913 | April 1994 | Heidelberg |
| 5997252 | December 1999 | Miller |
| 20010013703 | August 2001 | Croes, Valere |
| 20020079705 | June 2002 | Fowler, Benjamin P. |
| 6465901 | October 2002 | Croes, Valere |
| 20030102675 | June 2003 | Noethlichs, Leo |
| 20040047723 | March 2004 | Horjus, Thomas W. |
| 20050099013 | May 2005 | Tsuneo Noguchi |
| 6948905 | September 2005 | Horjus; Thomas W. |
| 7094017 | August 2006 | Kurita; Hidemi |
| 7215037 | May 8, 2007 | Scalzi; Saverio |

### BACKGROUND OF THE INVENTION

If wind power generator fan is big, then it needs large space such as wind farm. This wind power twin generator fan is small, it does not need extra space, it needs only platform space. Wind power twin generator include multiple system can produce more electricity in less space by using wind power smaller size twin generator that can be added as many as to meet specific needs. It can use for wind farm, residential, ship, automobile etc. It works either wind direction from right side or left side. Generating of electricity is maximized by full face of fan area.

### SUMMARY

Wind power twin generator include multiple system does not need large space area, it can produce more electricity in less space. Economically, it is very competitive to build it. Environmentally, it can be looking good. Needing place is very variety. It is safety by screen covering front of fan to protect bird or any material. It is prevented by solar panel for snow or any material falling to fan and it will add more producing electricity.

### BRIEF DESCRIPTION OF THE DRAWINGS

FIG. 1 is a view of wind power twin generator.

FIG. 2 is a view of one unit of wind power twin generator include multiple system that has two or more (drawing shows five) wind power twin generator FIG. 1.

FIG. 3 is a perspective and side view of one unit of wind power twin generator include multiple system FIG. 2.

FIG. 4 is a generator view of 1 in wind power twin generator FIG. 1.

FIG. 5 is a generator view of 2 in wind power twin generator FIG. 1.

FIG. 6 is a frame view of 3 in wind power twin generator FIG. 1.

FIG. 7 is a frame view of 4 in wind power twin generator FIG. 1.

FIG. 8 is a fan view of 5 in wind power twin generator FIG. 1.

FIG. 9 is a wind divider view of 6 in wind power twin generator FIG. 1.

### DESCRIPTION

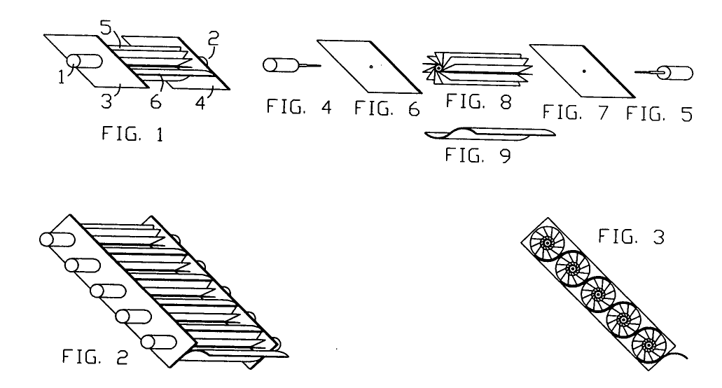

A unit of wind power twin generator include multiple system FIG. 2 has two or more wind power twin generator FIG. 1 as many as to meet specific needs.

Wind power twin generator include multiple system can add by attaching or with another unit of wind power twin generator include multiple system FIG. 2 as many as to meet specific needs.

A unit of wind power twin generator include multiple system FIG. 2 can be any shape.

Wind power twin generator include multiple system can pose any direction.

Wind power twin generator include multiple system can be any design.

Turning direction of generator FIG. 5 is opposite way of generator FIG. 4 for fan FIG. 8 turning direction.

Turning direction of fan FIG. 8 is depended on what angle of frame FIG. 6 and FIG. 7.

Fan FIG. 8 work either wind direction from right or left side by using wind divider FIG. 9

1. A “water mill” style wind power fan that can be any shape for turning generator to produce electricity.

2. Both end of fan of claim 1 having generator that turning direction is opposite way each other for fan turning direction.

3. Both end of fan of claim 1 having frame that generator of claim 2 attach to each side.

4. Between fan of claim 1 having wind divider that attached to both side frame of claim 3 for fan of claim 1 turn both wind direction.

5. A wind power twin generator that can pose any direction having fan of claim 1, generator of claim 2, frame of claim 3 and wind divider of claim 4.

6. A unit of wind power twin generator include multiple system that can be any shape having two or more wind power twin generator of claim 5

7. Wind power twin generator include multiple system can add by attaching or with another unit of wind power twin generator include multiple system of claim 6 as many as to meet specific needs.

8. Wind power twin generator include multiple system of claim 7 can pose any direction.

9. Wind power twin generator include multiple system of claim 7 can be any design.

10. Turning direction of fan of claim 1 is depended on what angle of frame of claim 3.

11. Fan of claim 1 be covered by screen for preventing bird or any material; it is option.

12. Wind power twin generator include multiple system of claim 7 be covered by solar panel for preventing snow to fan of claim 1 or add more electricity; it is option.

13. Wind direction guider for wind power twin generator include multiple system of claim 7; it is option.

14. Sizes, measurements, capacity of generator and overall designs may vary to meet specific needs.

15. Materials may very to meet specific needs.
